(19) United States
(12) Patent Application Publication
(10) Pub. No.: US 2009/0179124 A1
(43) Pub. Date: Jul. 16, 2009

(54) Computer and document stand

(75) Inventor: Joel M. Caplan, Northfield, NJ (US)

Correspondence Address: DILWORTH PAXSON LLP, 1500 Market Street, Suite 3500 E, PHILADELPHIA, PA, 19102, US

(73) Assignee: Nalpac Ingenuity, LLC, Northfield, NJ (US)

(21) Appl. No.: 12/316,519

(22) Filed: Dec. 12, 2008

Related U.S. Application Data
(60) Provisional application No. 61/007,345, filed on Dec. 12, 2007.
(60) Provisional application No. 61/126,894, filed on May 8, 2008.

(51) Int. Cl. F16M 11/38; F16M 11/00

(52) U.S. Cl. 248/176.1; 248/188.6

(57) ABSTRACT

A stand is provided for holding and elevating a laptop, notebook, or portable personal computer substantially to a user's eye level when facing forward, while at the same time minimizing the amount of desktop space occupied by the laptop. The stand comprises two panels pivotally attached through at least one hinge mechanism and, optionally, a brace mechanism. The stand may be expanded for use or collapsed for storage and transport. The stand is inexpensive to manufacture, lightweight, and easily portable because it is substantially flat when collapsed. The stand may include a built-in document holder that positions documents, notepads, or other materials directly in front of the user and just below the laptop's display and may also include at least one built-in cavity designed to hold a pad of paper, writing instruments, or other devices.

### CROSS REFERENCE TO RELATED APPLICATIONS

This application claims priority to U.S. Provisional Patent Application Ser. No. 61/007,345, filed Dec. 12, 2007, and U.S. Provisional Patent Application Ser. No. 61/126,894, filed May 8, 2008, the entireties of which are incorporated herein by reference.

### FIELD OF THE INVENTION

The invention relates to a stand for computers or other portable devices that may include both a display and a data input function, and for documents or other materials that users of laptop computers may reference or require while inputting or retrieving data from a laptop computer. More particularly, the invention relates to a collapsible and easily portable stand for computers, devices, documents, and other materials.

### BACKGROUND OF THE INVENTION

Laptop computers are popular alternatives to larger desktop computers. Laptop computers are used in significant numbers by computer users for business, educational, and personal purposes. The benefits of a laptop computer include portability, size, and functionality, which make laptop computers a preferred system in some cases.

There are clear benefits to using laptop computers. However, laptop computer use may cause problems for the user. Laptop computers may cause fatigue through long term use for a number of reasons. First, use of a laptop placed on a table, desk, lap of a user, or other support surface promotes bad posture because the laptop user must turn his or her eyes downward to view the screen and, at times, the head may follow the eyes. Second, long term downward positioning of the head and eyes may cause fatigue for the user. Third, and due to the configuration of an open laptop computer, laptop computer screen tend to be positioned at a distance from an edge of a desk, table or support surface and, consequently, far from a user's eyes. Accordingly, all of these problems may cause neck and back fatigue for the user and possibly strain on the user's eyes, which may be exacerbated with extended periods of use.

Several attempts have been made to provide laptop computer stands. For example, some laptop computer docking stations provide docking capabilities for laptop computers and promote dual use of the laptop computer as a portable computer and a desktop computer. Docking stations provide power for a laptop and also external connections to peripherals such as, for example, printers and networks. However, docking stations tend to be expensive and do not provide configurations that promote good posture or reduce strain on the eyes, neck, and back of a user. Docking stations also do not include practical features such as, for example, being lightweight, easily collapsible, or portable.

Laptop computer use may cause other problems for a user. For example, computer users frequently reference or require viewing documents or other materials to assist in inputting or retrieving data from a computer. Laptop computer users are at a greater disadvantage in comparison to desktop computer users when attempting to place documents or other materials in an easily readable or visible position, such as, for example, a location that is directly in front of the computer user and in close proximity to the computer's display. This disadvantage is caused by the integrated configuration of a laptop computer. The laptop computer incorporates the screen and keyboard into the whole of the computer, making the screen and keyboard inseparable from one another. For laptop computers, documents and other materials almost always must be placed to one side or the other of the laptop to allow for use of laptop.

Accordingly, there is a present need for a laptop computer stand configured to support the laptop on a minimal amount of space while elevating the laptop's screen for easier viewing. There is also a present need for a laptop computer stand to hold documents or other materials in front of the laptop user while the laptop is positioned on the stand. There is a further need for a laptop computer stand that supports a laptop computer in a manner that mitigates fatigue and even pain that is sometimes caused by staring downward at a laptop screen and/or by having to turn to the left or right of the laptop screen to view documents or other materials. There is yet a further need for a laptop computer stand that provides the foregoing functionality and that is also inexpensive to produce, lightweight, and easily collapsible into a substantially flat configuration when not in use so that it may be easily shipped, stored, and carried.

### SUMMARY OF THE INVENTION

The present invention provides a lightweight, collapsible, portable stand for supporting a laptop computer and documents or other devices or materials.

The stand comprises at least two panels that are connected by at least one hinge mechanism in one embodiment and, optionally, at least two hinged mechanisms in another embodiment. The at least one hinge mechanism and, optionally, the at least two hinged mechanisms of the stand are configured to extend the bases of the at least two panels into an expanded first position for use in supporting at least a laptop computer and to collapse the at least two panels into a substantially flat second position for storage and transport.

The at least two panels of the present invention are generally mirror images of one another. Accordingly, and in an embodiment, each panel may have a top surface, a support surface, a front surface, a bottom surface, and a back surface all of which define a general triangular geometry of the panel that also includes two side surfaces. In an embodiment, each panel may include at least one notch formed along the support surface of each panel. The at least one notch may be defined by a portion of the support surface and a projection, which may be angular, finger-like or other geometric configuration, provided along the support surface. In another embodiment, the stand may comprise two notches formed along a support surface of the panel. The two notches may be defined by a portion of the support surface, and any number of projections provided along the support surface in near proximity to the front surface of the panel.

The first panel and the second panel each comprise a bottom surface between about greater than one degree to less than 89 degrees from the support surfaces of the panels upon which a bottom surface of the electronic device rests when the stand is in use.

The stand comprises a first panel and a second panel joined with at least one pivotable joint to the first panel. The first panel and the second panel each provide at least one support surface adapted to receive the item. The stand comprises at least one pivotable joint formed at an edge of a top surface of the first panel and a surface of the second panel. Additionally, at least one pivotable joint may be formed at an edge of a top surface of the first panel and an edge of a top surface of the second panel. Furthermore, multiple pivotable joints may be formed between partitions and the panels. The stand may be closed about the pivotable joint into a substantially flat configuration.

In an embodiment, the at least one hinge mechanism of the stand of the present invention is provided to connect the panels to one another and is positioned adjacent to the top surfaces of each panel. The at least one hinge mechanism allows the panels to move about an axis from a expanded first position for use and to a substantially flat second position for storage and transport. In another embodiment, a flexible or foldable extension support device may connect the panels along a portion of the bottom surfaces of each panel and limit the length of expansion of the panels from one another about at least one of the pivotable joints.

In yet another embodiment, several hinges of the stand of the present invention may be provided with foldable partitions to connect the panels to one another. The hinges and foldable partitions support movement of the panels of the stand from a expanded first position for use and to a substantially flat second position for storage and transport. Hinges and foldable partitions may be provided at the back of the stand to connect the panels adjacent to a portion of the back surface of each panel. Hinges may be adapted to allow the partitions to fold away from the panels of the stand when in a substantially flat second position. Other hinges and braces may be provided at the bottom of the stand to connect the panels adjacent to a portion of the bottom surface of each panel. The bottom hinges may be adapted to allow braces to fold between the panels of the stand when in a substantially flat second position.

The stand comprising at least one brace member, wherein the at least one brace member limits an opening distance formed between the first panel and the second panel in an open position. The at least one brace member may fold between the first panel and the second panel when the stand is in a closed position. The at least one brace member may fold away from the first panel and the second panel when the stand is in a closed position.

In embodiments, the stand in the expanded first position may be placed on a support surface such as, for example, a table, desk, or other surface and then a laptop computer may be placed on the stand with the bottom of the computer resting on the support surfaces of the panels and the front portion resting in the first notches provided by the support surface and a angular projection. The laptop screen may be extended away from the laptop keyboard and elevated to a user's eye level. In the expanded first position, documents or other materials may be placed in the second notch that may be provide along the support surface of the panels.

In embodiments, the stand of the present invention may be collapsed into a substantially flat second position for storage or transport.

The stand may comprise one or more cavities or depressions in at least one of the first panel and the second panel designed to retain writing instruments, pads of paper, digital media, and/or laptop accessories.

A plurality of holes are provided in the first panel and the second panel to allow the stand to fit into a binder for transport or storage.

### BRIEF DESCRIPTION OF THE DRAWINGS

FIG. 1A is a side view of an embodiment of a stand of the present invention.

FIG. 1B is a side view of a panel of another embodiment of a stand of the present invention.

FIG. 2 is a top view of the stand shown in FIG. 1A in a closed position.

FIG. 3A is a top view of the embodiment of the stand shown in FIGS. 1A and 2 in an opened position

FIG. 3B is a front view of the embodiment of the stand shown in FIG. 1B in an opened position.

FIG. 4A is a perspective view of another embodiment of a stand of the present invention in an opened position.

FIG. 4B is a perspective view of the embodiment of the stand shown in FIGS. 1B and 3B in an opened position.

FIG. 5A is a side view of the embodiment of the stand shown in FIG. 4A supporting a laptop computer and a letter-sized pad of paper.

FIG. 5B is a side view of the embodiment of the stand shown in FIGS. 1B, 3B, and 4B supporting a laptop computer and a letter-sized pad of paper.

FIG. 6 is a perspective view of a stand of the present invention stored in a closed position within a 3-ring binder.

### DETAILED DESCRIPTION OF EMBODIMENTS OF THE INVENTION

In reference to the FIGUREs hereto, the present invention provides embodiments 10 and 210 of a stand, for elevating a display of a foldable computer device to about eye-level of a user or to a height above a support surface. The stand of the present invention also provides a convenient resting surface directly in front of a user to place documents or other materials. The stand promotes ergonomic positioning and use of an electronic computer device. The stand of the present invention may be manufactured with lightweight materials and may also be collapsible for easy storage and transport. Various embodiments are provided with the disclosure of the present invention and are shown and described in this application.

Generally, the stand of the present invention comprises a first panel joined by at least one pivotable joint to a second panel. Support surfaces are provided by the first panel and the second panel of the stand of the present invention. The support surfaces are adapted to receive an item, such as, for example, a foldable electronic device having a display. At least one notch may be provided on each support surface of each panel and support the foldable electronic device on the stand. The stand of the present invention is configured to be used in an open position where the first panel and the second panel may be extended from one another while implementing the at least one pivotable joint which joins the first panel to the second panel. The configuration also allows the stand to be folded into a closed position for storage or transport. A brace member may be provided with the stand to limit the extension of the first panel from the second panel, when in use. Optionally, partitions may be provided to support an electronic device positioned on the support surfaces of the panels of the stand.

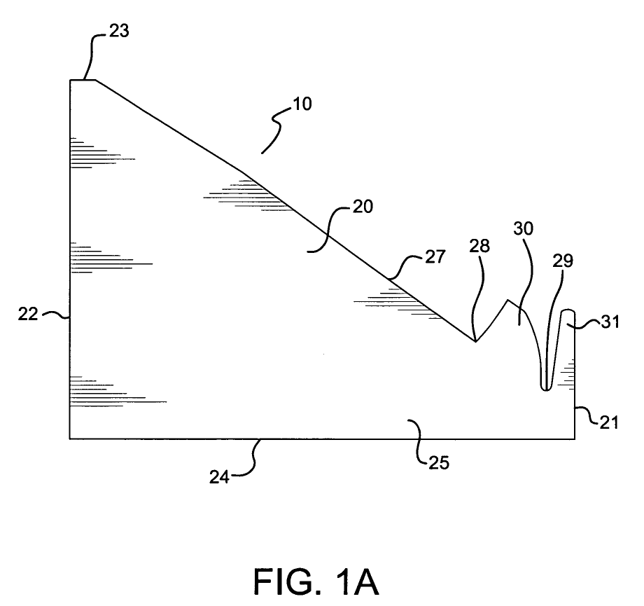

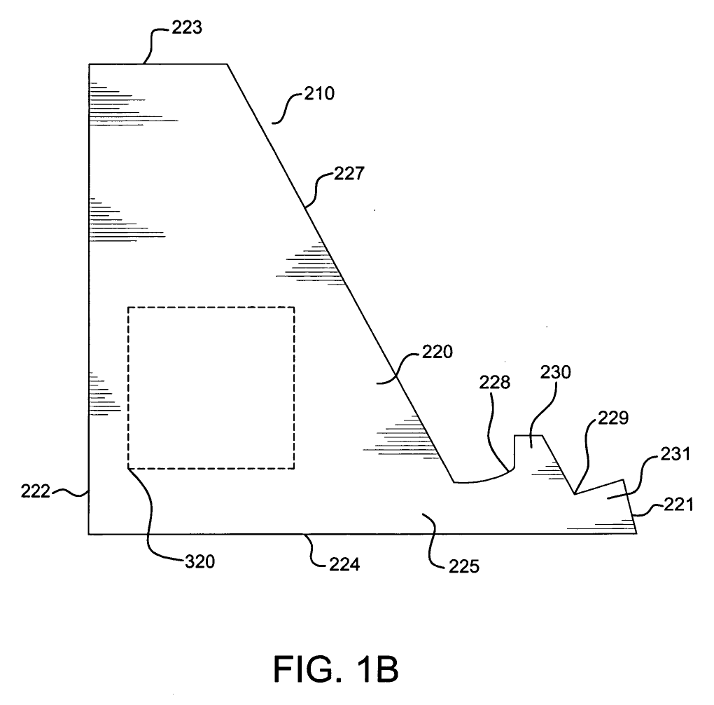

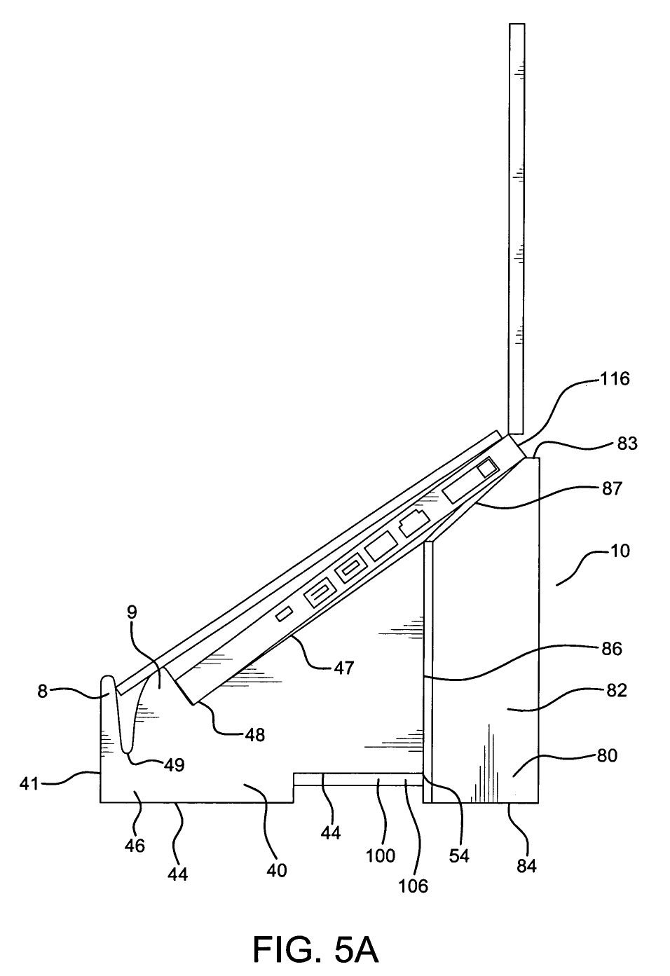

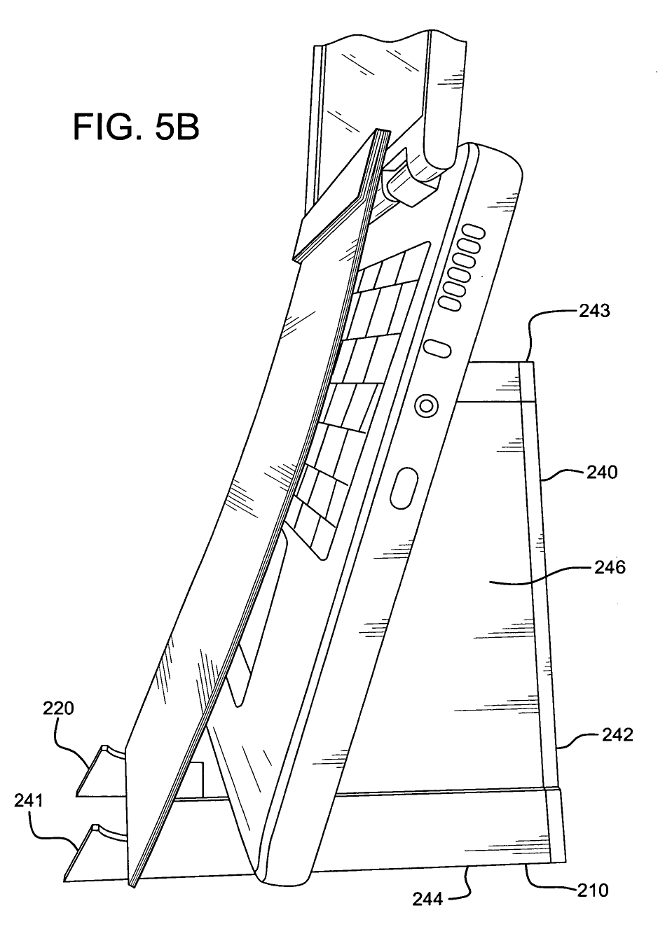

Referring now to the views shown throughout FIGS. 1A, 2, 3A, 4A, 5A, and 6, a first embodiment of stand 10 is shown and illustrated. Stand 10 comprises first panel 20 and second panel 40 which are generally mirror images of one another. Respectively, each panel 10 and 40 may be provided in a generally triangular-shaped configuration as shown in FIG. 1A. Panels 20 and 40 have front surfaces 21 and 41, back surfaces 22 and 42, bottom surfaces 24 and 4, first side surfaces 29 and 48, second side surfaces 26 and 46, and support surfaces 27 and 47 that may be sloped.

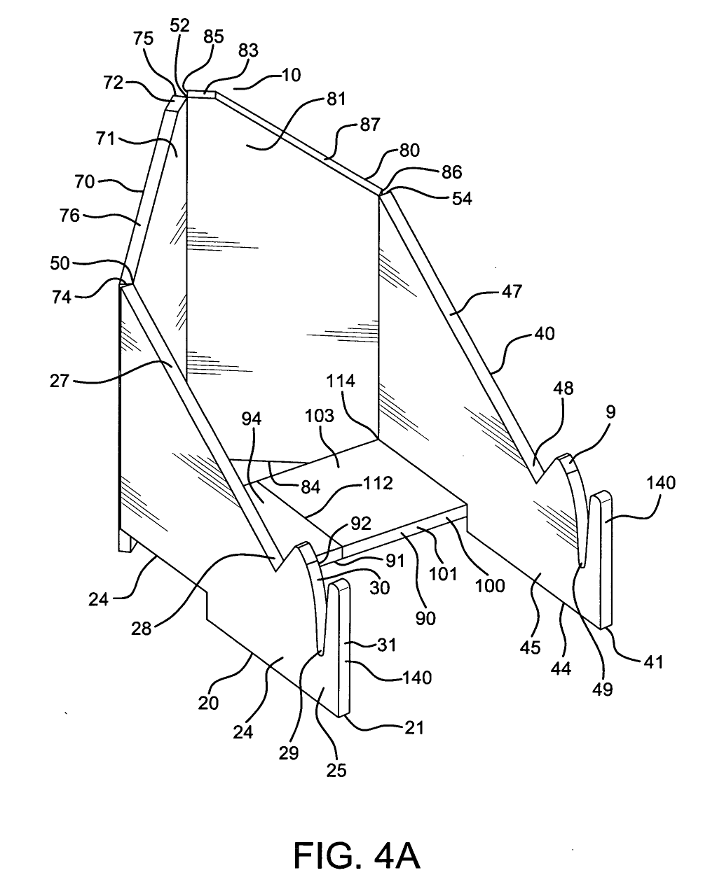

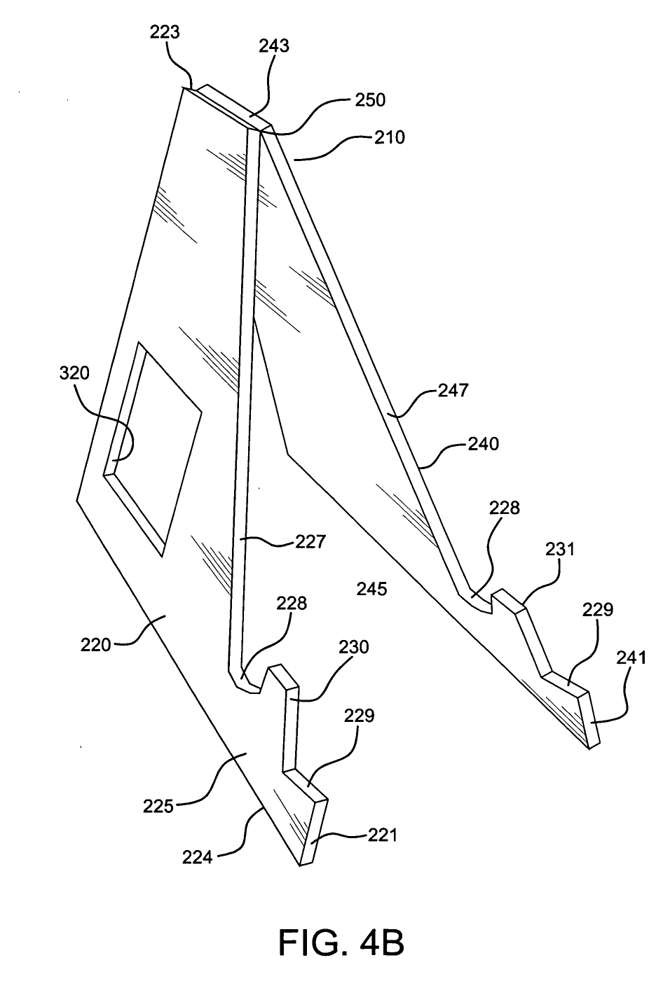

At least one notch 28 and 48, as shown particularly in FIG. 4A, may be provided along support surfaces 27 and 47 of each panel 20 and 40, respectively. Notches 28 and 48 may be defined by angular projections 30 and 9 and/or finger-like projections 31 and 8 from the panels 20 and 40, respectively. Additional notches may be provided in different shapes, configurations, and numbers in other embodiments.

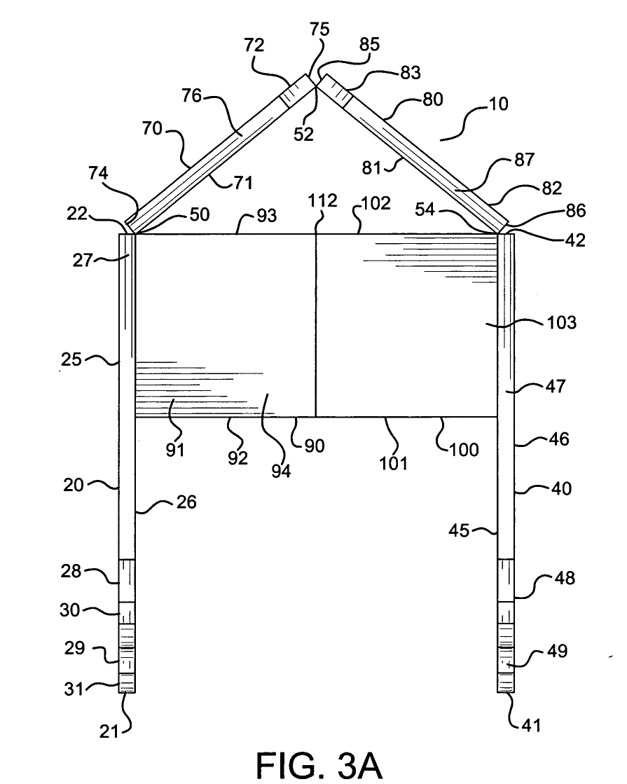

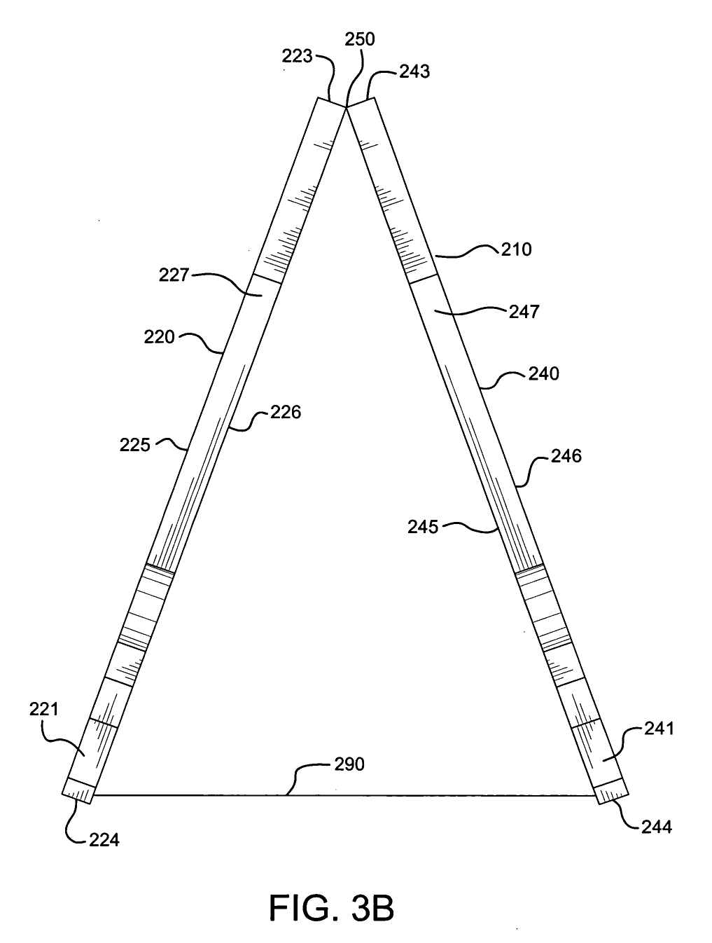

Referring now to FIGS. 3A and 4A, first panel 20 may be joined through at least one pivotable joint 50 by at least two partitions 70 and 80 with second panel 40. Partitions 70 and 80 may be mirror images of one another, and each may have at least top surface 72 and 83, bottom surface 73 and 84, front surface 71 and 81, back surface 5 and 82, first side surface 74 and 85, second side surface 75 and 86 and, optionally, a support surface 76 and 87 that continues with and extends along the same plane of support surfaces 27 and 47 of first panel 20 and second panel 40, respectively. In this embodiment, pivotable joint 50 may be provided between a portion of an edge of a back surface 22 of first panel 20 and a portion of an edge of a first side surface 74 of first partition 70. Another pivotable joint 52 may be provided between edge of second side surface 75 of first partition 70 and an edge of first side surface 85 of second partition 80. A further pivotable joint 54 may be provided between another edge of a second side surface 86 of second partition 80 and a portion of an edge of back surface 42 of second panel 40. Pivotable joints 50, 52, and 54 allow first partition 70 and second partition 80 to fold from an open position for use and a closed and substantially flat position for storage and transport.

In alternative embodiments, pivotable joints may also be provided between an edge of a surface of any panel, partition, and/or brace and a surface of any panel, partition, and/or brace. The pivotable joints may be molded plastic that forms a part of the panels, partitions, and/or braces, hinges, fabric, or other suitable mechanism for creating a moveable joint or connection between panels, partitions and/or braces.

Referring now to FIGS. 3A and 4A, brace member 90 may be provided to join first panel 20 and second panel 40 adjacent their bottom surfaces 24 and 44, respectively. Brace member 90 may comprise first brace element 91 and second brace element 100 that are mirror images of one another. Each brace element 91 and 100 may comprise front surfaces 92 and 101, back surfaces 93 and 102, top surfaces 94 and 103, bottom surfaces 95 and 104, first side surfaces 96 and 105, and second side surfaces 97 and 106, respectively. Brace elements 91 and 100 may be square, rectangular, or other suitable geometric shape. A pivotable joint 110 may join an edge of a bottom surface 24 of first panel 20 to an edge of a first side surface 96 of first brace element 91. Another pivotable joint 112 joins an edge of a second side surface 97 of a first brace element 91 to an edge of a first side surface 105 of second brace element 100. A further pivotable joint 114 joins an edge of a second side surface 106 of a second brace element 100 to an edge of bottom surface 44 of second panel 40.

In alternative embodiments, pivotable joints may also be provided between an edge of a surface of the brace and a corresponding surface of any panel, partition, and/or brace.

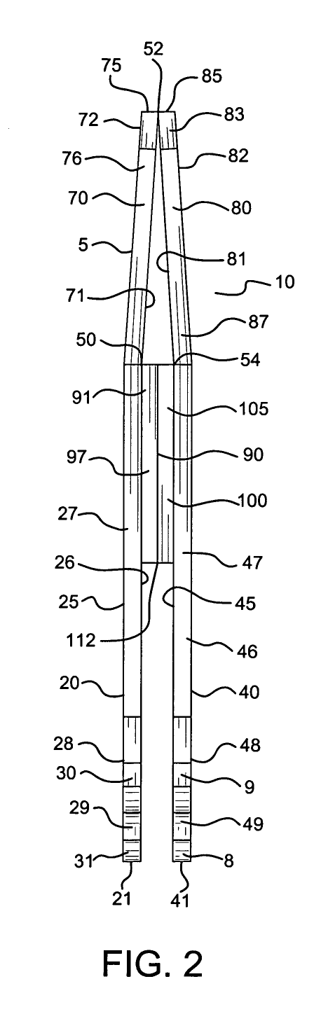

Referring now to FIGS. 2, 3A, and 4A, a first embodiment of stand 10 is shown. FIG. 2 shows stand 10 in a closed position where the partitions 70 and 80 are folded away from first panel 20 and second panel 40 and brace member 90 is folded between first panel 20 and second panel 40. In the closed position shown in FIG. 2, stand 10 is substantially flat. FIGS. 3A and 4A shows stand 10 in an open position for use. In the open position shown in FIGS. 3A and 4A, first panel 20 and second panel 40 are extended away from one another and connected to one another along edges of back surfaces 22 and 42 with partitions 70 and 80 and at edges of the bottom surfaces 24 and 44, respectively, with brace member 90. In the open position, first partition 70 and second partition 80 in the open position are at an angle from one another. Also, first brace element 91 and second brace element 100 of brace member 90 create a substantially flat surface whereby the bottom surface 95 of first brace element 91 rests against bottom surface 104 of second brace element 100.

Referring now to FIGS. 1A, 2, 3A, 4A, 5A, and 6, first notches 48 and second notches 49 are provided on support surfaces 27 and 47 of first panel 20 and second panel 40. First notches 48 are defined by a portion of support surfaces 27 and 47 and a surface of angular projections 30 and 9 provided with first panel 20 and second panel 40. Second notches 49, adjacent to first notches 48, are defined by another surface of angular projections 30 and 9 and finger-like projections 31 and 8 provided with first panel 20 and second panel 40, respectively. First notches 48 may, along with support surfaces 27 and 47 of first panel 20 and second panel 40 and support surfaces 76 and 87 of first partition 70 and second partition 80, contact a portion of bottom surface of a computer device thereby supporting computer device in stand 10 with support surfaces of angular projections 30 and 9 of first notches 48. Second notches 49 defined by finger-like projections 30 and 9 and angular projections 30 and 9 may be used to support paper, documents or other materials in front of computer device resting on stand 10.

Referring now to the various views shown throughout FIGS. 1B, 3B, 4B, and 5B, a second embodiment of stand 210 is shown and illustrated. Stand 210 comprises a first panel 220 and second panel 240 which are generally mirror images of one another. Each panel 220 and 240 may be provided in a generally triangular-shaped configuration as shown in FIG. 1B. Each panel 220 and 240 has front surfaces 221 and 241, back surfaces 222 and 242, top surfaces 223 and 243, bottom surfaces 224 and 244, first side surfaces 225 and 245, second side surfaces 226 and 246, and support surfaces 227 and 247, respectively. At least one notch 228 may be provided on each support surface 227 and 247 by way of an angular projection 230. Additional notches may be provided with other embodiments.

Referring now to FIGS. 3B and 4B, first panel 220 may be joined through at least one pivotable joint 250 with second panel 240. In this embodiment, pivotable joint 250 may be provided between a portion of an edge of a top surface 223 of the first panel 220 and a portion of an edge of top surface 243 of second panel 240. In alternative embodiments, pivotable joints may also be provided between an edge of a surface of any panel, partition, and/or brace and a surface of any panel, partition, and/or brace. Pivotable joint 250 allows first panel and second panel to fold about an axis of the pivotable joint 250 from an open position for use to a closed and substantially flat position for storage and transport.

Referring now to FIGS. 3B and 4B, brace member 290 may be provided to join first panel 220 and second panel 240 adjacent their bottom surfaces 224 and 244, respectively, similar to brace member 90 in the first embodiment. Brace member 290 may also be provided as a piece of fabric or other thin and/or flexible material.

Referring now to FIGS. 3B, 4B, and 5B, the second embodiment of stand 210 is shown. FIGS. 3B, 4B, and 5B show stand 210 in an open position for use. In the open position shown in FIGS. 3B, 4B, and 5B, first panel 220 and second panel 240 are extended away from one another and connected to one another adjacent top surfaces 223 and 243 of first panel 220 and second panel 240, respectively, with optional brace member 290 shown in FIG. 3B.

Referring now to FIGS. 3B, 4B, and 5B, first notches 228 and second notches 229 are provided on support surfaces 227 and 247 of first panel 220 and second panel 240. First notches 228 are defined by a portion of support surfaces 227 and 247 and a surface of first projections 230 provided with first panel 220 and second panel 240. Second notches 229, adjacent to first notches 228, are defined by another surface of first projections 230 and second projections 231 provided with first panel 220 and second panel 240, respectively. First notches 228 may, along with support surfaces 227 and 247 of first panel 220 and second panel 240, contact a portion of bottom surface of a computer device, thereby supporting computer device in stand 210 with support surfaces of first notches 228. Second notches 229 may be used to support paper, documents, or other materials in front of computer device resting on stand 210.

While the embodiments of the stand of the present invention may be made from solid materials such as wood or plastic, it may just as readily be made from other materials such as glass, foam, metal, cardboard, rubber, wire, pipe, or other suitable material. The choice of material is not critical, provided that the material is of sufficient rigidity to support a laptop computer when any embodiment of stand is assembled and in use.

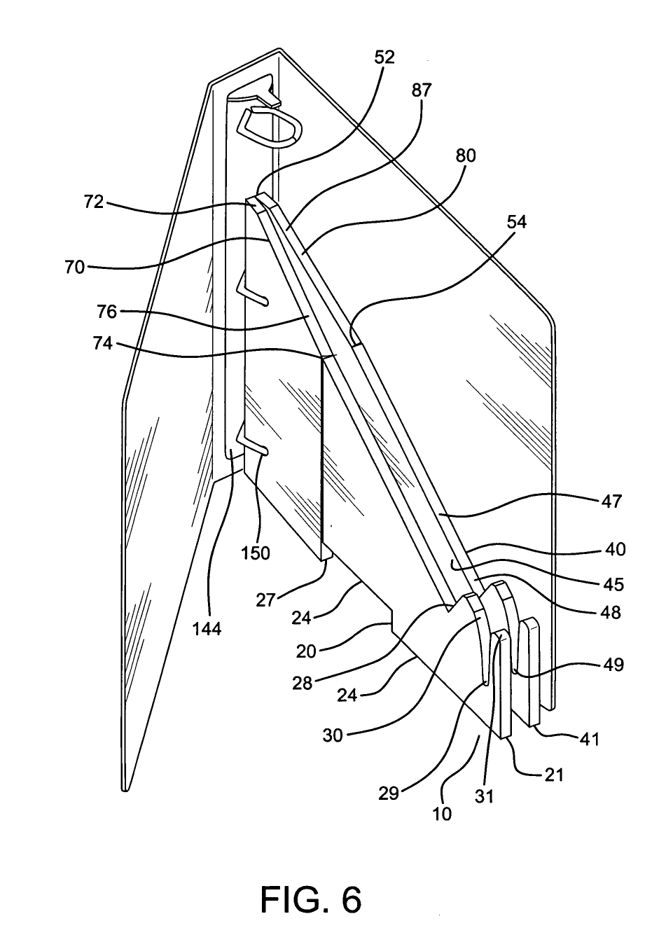

Embodiments of the invention may provide a plurality of holes 144 through the first panel and the second panel or the first partition or second partition, as shown in FIG. 6, to allow the stand to fit into a binder for storage or transport. In a particular embodiment having a plurality of holes, the first panel may be joined with a pivotable joint to a first partition, and a second panel may be joined with a pivotable joint to a second partition. The partitions are not joined to one another. A plurality of holes may be provided in the partitions so that the stand may be stored and used with a three ring or other binder. For example, and as shown generally in FIG. 6, the partitions are secured to a binder with plurality of holes. The stand may be closed within the binder to a substantially flat configuration and opened for use, while still secured to a binder. Optionally, a brace mechanism as shown in the other embodiments of the invention may be incorporated in the stand.

Embodiments of the invention provide storage and dispensing configurations for holding and/or dispensing notepaper, writing instruments, digital media, and/or laptop accessories. For example, a cutout 320 shown in FIGS. 1B and 4B may be adapted to hold a post-it pad.

The invention provides people and businesses that use laptop computers as a primary means for computing—rather than a desktop compute—with a ergonomic stand for a laptop computer that promotes proper posture and less fatigue as a user does not need to be positioned in an uncomfortable, crouched position when using the laptop on a desktop, tabletop, or lap, particularly when viewing or referencing documents or other materials.

In embodiments of the invention, a laptop positioned on the stand may incorporate a voice recognition software program or second plug in keyboard and/or mouse, such that the keyboard and/or touchpad of the laptop computer may not be needed.

In another embodiment of the invention, a laptop positioned on the stand may be used as a multimedia device such that the display of the laptop is better configured to serve as a monitor for displaying and viewing videos, games, slideshows, pictures, or other multimedia content. The stand of the present invention also positions the laptop's speakers to promote better sound. This positioning of the laptop computer on the stand of the present invention not only elevates the computer on support surfaces of the stand, but also enhances cooling of the laptop, which incidentally may extend the laptop's useful life.

It is anticipated that this invention will find various promotional uses. Therefore, it is anticipated that the stand may be stamped, etched, engraved, and/or screen-printed with company logos or other promotional information.

While preferred embodiments of the present invention have been shown and described, it will be apparent to those skilled in the art that many changes and modifications may be made without departing from the invention in its broader aspects. The appended claims are intended to cover, therefore, all such changes and modifications as fall within the true spirit and scope of the invention.

I claim:

1. A stand for supporting an item, the stand comprising:
a first panel; and
a second panel joined with at least one pivotable joint to the first panel,
wherein the first panel and the second panel each provide at least one support surface adapted to receive the item.

2. The stand of claim 1, wherein the at least one pivotable joint is formed at an edge of a top surface of the first panel and a surface of the second panel.

3. The stand of claim 1, wherein the at least one pivotable joint is formed at an edge of a top surface of the first panel and an edge of a top surface of the second panel.

4. The stand of claim 1, wherein the stand may be closed about the pivotable joint into a substantially flat configuration.

5. The stand of claim 1, wherein at least one pivotable joint is formed at an edge of a back surface of the first panel and at least one pivotable joint is formed at an edge of a back surface of the second panel.

6. The stand of claim 5, wherein the stand may be closed about the pivotable joint into a substantially flat configuration.

7. The stand of claim 1, wherein the support surface of each of the first panel and the second panel is adapted to receive a foldable electronic device having a display.

8. The stand of claim 1, wherein at least one notch is provided on each support surface of the first panel and the second panel.

9. The stand of claim 7, wherein a first notch and a second notch are provided on each support surface of the first panel and the second panel.

10. The stand of claim 9, wherein the first notch of the first panel and the first notch of the second panel is adapted to support a surface of a foldable electronic device having a display.

11. The stand of claim 9, wherein the second notch of the first panel and the second notch of the second panel are adapted to receive notebooks, papers, notepads, documents, or other materials.

12. The stand of claim 1, wherein the first panel and second panel may comprisewood, glass, metal, plastic, or lightweight composite material.

13. The stand of claim 1, wherein the first panel and the second panel each comprise a bottom surface between about greater than one degree to less than 89 degrees from the support surface upon which a bottom surface of the electronic device rests.

14. The stand of claim 1, further comprising:
at least one brace member,
wherein the at least one brace member limits an opening distance formed between the first panel and the second panel in an open position.

15. The stand of claim 14, wherein the at least one brace member may fold between the first panel and the second panel when the stand is in a closed position.

16. The stand of claim 14, wherein the at least one brace member may fold away from the first panel and the second panel when the stand is in a closed position.

17. The stand of claim 1, wherein the stand may comprise one or more cavities or depressions in at least one of the first panel and the second panel designed to retain writing instruments, pads of paper, digital media, and/or laptop accessories.

18. The stand of claim 1, wherein a plurality of holes are provided in the first panel and the second panel to allow the stand to fit into a binder for transport or storage.

19. A stand for supporting a laptop computer, the stand comprising
a first panel moveably joined with at least one foldable mechanism with a second panel,
support surfaces on the first panel and the second panel for supporting the laptop, and
at least one hinge provided to connect the first panel and the second panel.

20. The stand of claim 19, wherein the at least one foldable mechanism provides support surfaces for supporting a laptop.
